(19) United States
(12) Patent Application Publication
(10) Pub. No.: US 2023/0314657 A1
(43) Pub. Date: Oct. 5, 2023

(54) Climate risk and impact analytics at high spatial resolution and high temporal cadence

(71) Applicants: Tristan Ballard, San Francisco, CA (US); Matthew Cooper, San Francisco, CA (US); Gopal Erinjippurath, San Francisco, CA (US)

(72) Inventors: Tristan Ballard, San Francisco, CA (US); Matthew Cooper, San Francisco, CA (US); Gopal Erinjippurath, San Francisco, CA (US)

(21) Appl. No.: 18/129,862

(22) Filed: Apr. 2, 2023

Related U.S. Application Data
(60) Provisional application No. 63/326,816, filed on Apr. 2, 2022.

(51) Int. Cl. G01W 1/10

(52) U.S. Cl. CPC G01W 1/10

(57) ABSTRACT

Environmental information combined with satellite driven observations and ground observations to create a predictor for wildfire at high spatial resolution. Temperature and precipitation are bias corrected using modeling and processing techniques driven from reanalysis datasets. Such techniques can be used to provide projections of future climate risk data at high temporal cadence over individual addresses or over large regions using spatial aggregation using polygon processing techniques.

### CROSS REFERENCE TO RELATED APPLICATIONS

This application claims the benefit of priority to U.S. Provisional Patent Application Ser. No. 63/326,816, entitled “Climate risk analytics at high resolution and cadence,” Atty Ref SUST-0300, filed 2 Apr. 2022, which is hereby incorporated by reference in its entirety.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

### Field

The present application relates to Climate Risk.

### Description of Related Art

Various climate models have been proposed and are in use for various purposes.

### SUMMARY

The present inventors have realized the challenge properly accounting for climate change in AI-based approaches to long-term fire risk modeling, as much future fire risk is outside of the available feature space provided by the historical record. The challenge is inherent to many climate change impacts and may be addressed via a novel model form that makes monotonic and interpretable predictions in novel fire weather environments. This model outperforms other neural networks and logistic regression models when making predictions on unseen data from a decade into the future. The model may be used to drive a user interface of fire risk (or damage projections) with features for customizing the output over a map of a plant, city, region, or continent or other desired area.

The present application describes many embodiments and no single feature or component of one embodiment is exclusive thereto or required in any other embodiment even if described or implied as important to a particular embodiment.

In one embodiment, a method is provided for climate risk analysis, comprising the steps of preparing or retrieving a set of projections of climate variables from varied sources that are optionally harmonized to the same spatial and temporal resolution, preparing or retrieving a set of historic observations of climate variables from varied sources that are optionally harmonized to the same spatial and temporal resolution, preparing or retrieving a set of historic estimates of the indicator over an extended period of time, preparing or retrieving a data profile representing the climate zones across at least one geography, preparing or retrieving at least one land cover profile representing environmental factors across the geographies, and automatically preparing and applying data transformations to the projections in light of the observations, estimates, and profiles to determine a climate related risk.

The method may further comprising a machine learning module that learns to use datasets comprising one or more of the observations, estimates, and profiles to learn risk exposure susceptibility metrics and create projections of risk exposure metrics based on future projections and environmental factors. The projections of risk exposure metrics accounts for environmental land cover profiles. Satellite data from multiple sensors may be utilized for the historic observations and land cover profiles. At least one of the projections may comprise a plurality of data streams where in at least one of the data streams is super resolved to match a highest resolution of other streams.

In another embodiment, a method of updating and/or correcting biases in model simulations is provided and such corrections are based on a generative machine learning system that learns the properties of climate projections from historic observations. The biases may be updated and/or corrected biases in model simulations based on a generative adversarial machine learning system. The method may use one or more of climate observations, topography, land cover, and/or other environmental sensor data as inputs to a discriminator module in the generative adversarial machine learning system. Historic weather observations may be used as inputs to the discriminator module in the generative adversarial machine learning system, and one or more of the inputs may be super-resolved.

In yet another embodiment, a method is provided for learning and processing modules that comprises performing a distributed processing of spatial inputs served as a spatial feature which would be one of the polygons, line strings, points or multipolygons, filtering weights based on the region of processing, mapping of polygons to a specific set of grid cells representing climate projections from a plurality of models, and weighting and aggregating the values from multiple grid cells to a single value for each spatial feature. The method may, for example, precompute polygon(s) based outcomes and stored in memory or in a database, and an incoming polygon may be spatially matched with one or more precomputed polygons through a spatial intersection or overlap of the intersecting polygons are aggregated to serve an outcome for each polygon. The precomputation may be a super resolved risk exposure data stream in advance of storage in memory or in a database. Precomputation factors in the spatial resolution of regions may be super resolved to a specific set of polygons based on the resolution of the polygon.

The methods may all include a user interface displaying risk exposure at an asset or property level that indicates the risk exposure computed as a result of processing indicated by one or more of the methods and shown on a map which may comprise a collection of assets as points or regions and may be polygons. The user interface may further comprise options to adjust any of the spatial inputs and/or features or any of the weights, mappings, or aggregations and display a before and after visual representation of a climate risk scenario determined from the steps in any of the methods. In one embodiment, the user interface includes a super-resolution button that applies super-resolution to one or more of the spatial inputs which may be selected on the user interface.

Portions of the embodiments, whether a device, method, or other form, may be conveniently implemented in programming on a general purpose computer, or networked computers, and the results may be displayed on an output device connected to any of the general purpose, networked computers, or transmitted to a remote device for output or display. In addition, any components of any embodiment represented in one or more computer program or module(s), data sequence(s), and/or control signal(s) may be embodied as an electronic signal broadcast (or transmitted) at any frequency in any medium including, but not limited to, wireless broadcasts, and transmissions over copper wire(s), fiber optic cable(s), and co-ax cable(s), etc.

### DESCRIPTION OF THE DRAWINGS

A more complete appreciation of the various embodiments and many of the attendant advantages thereof will be readily obtained as the same becomes better understood by reference to the following detailed description when considered in connection with the accompanying drawings, wherein:

FIG. 1 is a set of graphs showing a distribution of the Keetch-Byram Drought Index (KBDI);

FIG. 2 is an example architecture and loss function; and

FIG. 3 is a schematic diagram of the data flow in making predictions with the pre-trained model;

FIG. 4A is a graph illustrating False Positive vs. True Positive for the model and others;

FIG. 4B is a graph of Log Loss for the model and others;

FIG. 5 is a block diagram of a network (ClimaGAN) that combines super-resolution and a contrastive unpaired translation GAN according to an embodiment;

FIG. 6 is a block diagram illustrating an embodiment transitioning from a polygon region to a polygon level risk exposure dataset according to an embodiment;

FIG. 7 is a block diagram illustrating a multiple polygon aggregation using Split-Apply-Combine methodology according to an embodiment;

FIG. 8 is a block diagram illustrating Workflow for accelerated access to risk datasets; and

FIG. 9 is a block diagram illustrating a process that includes bias correction models at high resolution.

### DESCRIPTION

Wildfires are one of the most impactful hazards associated with climate change, and in a hotter, drier world, wildfires will be much more common than they have historically been. However, the exact severity and frequency of future wildfires are difficult to estimate, in least in part because fire is influenced by a variety of complex factors and climate change will create novel combinations of vegetation and fire weather outside what has been historically observed. In the long term, topography, vegetation types, ecological zone, and human access all affect a location's baseline fire risk, while weather factors like precipitation, wind speed, and temperature affect a location's fire risk in the short-term.

Given that fire risk is a function of complex interactions among many different variables, predicting fire risk would be very amenable to a machine learning approach. Such an approach would involve taking millions of satellite observations of fire risk from around the world, combining those observations with information on a wide array of on-the-ground risk factors, and then predicting wildfires over the world's surface under varying future conditions. This approach would work very well for predicting current fire risk, but would likely fail for predicting future fire risk. This is because a major determinant of fire risk is weather—and because of climate change, future weather will be quite different from historic weather conditions.

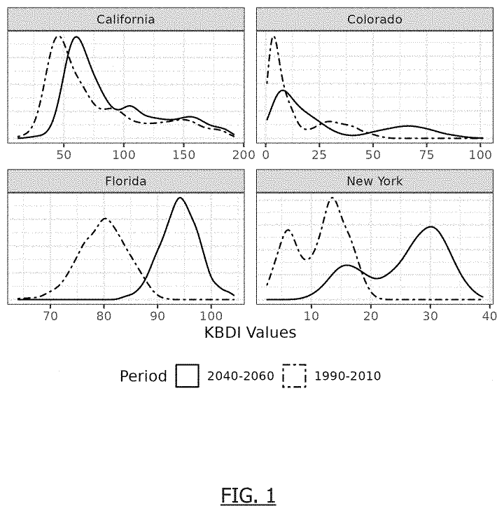

Referring now to the drawings, wherein like reference numerals designate identical or corresponding parts, and more particularly to FIG. 1 thereof, there is illustrated a distribution of the Keetch-Byram Drought Index (KBDI) 100, an indicator of fire weather, in the main ecological zone of four different states (Distribution of mean annual Keetch-Byram Drought Index values in four states under observed historic and modeled future climate regimes). A Distribution of mean annual Keetch-Byram Drought Index values in four states under observed historic and modeled future climate regimes. In each of these states, future distributions of KBDI values will be higher than historic distributions. In Florida 110, for example, the most common historic KBDI value was 80, but by the mid-21st century, this will likely be 95, a value beyond the range of historic observations. One problem addressed then becomes how to predict future fire risk in Florida (or other locales) when future fire weather will be beyond historically observed values. Unfortunately, traditional machine learning is notoriously brittle outside the feature space of its available training data, and thus will likely fail when predicting future fire risk.

In one embodiment, a new neural network architecture based on two premises is provided. The first is that the relationship between KBDI and fire probability is monotonic, and as ongoing climate change leads to conditions drier than any previously observed in many locations, it will be necessary to use models that can extrapolate monotonically, such as logistic regression models. Secondly, the parameterization of the weather-fire relationship is complex and context dependent, with a large number of influencing variables that interact nonlinearly, requiring models like neural networks that can handle such estimation problems.

Drawing from both of these premises, a neural network architecture that uses a large number of features describing the geographic context to estimate parameters of a logistic model that describes the KBDI-fire relationship in that context. In this example, features for the spatial location, local land cover type, and historic climate zones indicative of prevailing vegetation communities may be utilized; however, this architecture could be extended to incorporate other important features, such as topography, proximity to human settlements, or above ground biomass. This approach has the advantage of drawing on complex interactions within the geophysical environment that influence the relationship between fire and weather conditions, while still being constrained to make predictions in line with our strong prior assumption that the relationship between dryness and fire risk is monotonic. In one embodiment a combination of any of the above features (including combinations of features that may have synergy) may be utilized as shown:

TABLE 1
Exemplary Table of Features Combinations:

| | | | | | | Other feature(s), |
|---|---|---|---|---|---|---|
| | local land | historic | | | human | and/or proximity |
| Feature | cover | climate | | above ground | settlement(s) | to other |
| combination | type, | zones | topography | biomass | proximity | feature(s) |
| 1 | * | | | | | |
| 2 | | * | | | | |
| 3 | * | * | | | | |
| 4 | | | * | | | |

·
·
·

| | | | | | | |
|---|---|---|---|---|---|---|
| n-1 | | * | * | * | * | * |
| n | * | * | * | * | * | * |

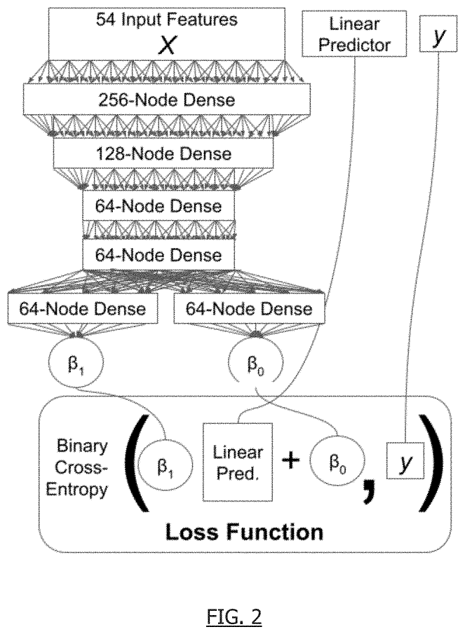

The model feeds the features (e.g., a large number of features) in four dense hidden layers that condense from 32 to 8 nodes with a ReLU activation function. The model then diverges into two separate hidden layers, each of which converges into a single-parameter output, which are treated as the two parameters in a logistic regression (β0 and β1). The model's loss function is therefore the performance of those two parameters in a logistic regression using observed KBDI, evaluated with binary cross-entropy. FIG. 2 illustrates an example architecture 200 used in modeling fire risk that can extrapolate monotonically into future fire weather values outside the range of observed training data, and loss function 210. And is an Overview of architecture used in modeling fire risk that can extrapolate monotonically into future fire weather values outside the range of observed training data.

While many variables contribute to fire weather (or other outcomes as the techniques described here can be applied elsewhere)—most notably temperature, precipitation, and wind, several indices exist that combine multiple variables into one aggregate metric of risk. In one embodiment, a model architecture extrapolates linearly for one variable, a selection of which included considerations/assessment for both Vapor Pressure Deficit and Keetch-Byram Drought Index (KBDI) (Keetch and Byram 1968) globally and in the United states at a 0.125 degree (˜12 km) resolution, and comparing these values against Modis MCD64A1 fire observations resampled to the same 0.125 degree resolution, found that KBDI was more correlated with fire burnt area than Vapor Pressure Deficit (VPD). Under such circumstances, KBDI may utilized over VPD. In one embodiment, an analysis of a number of indexes may be performed for any one or multiple areas, biomes, etc., and an index most favorable for a desired area may be selected. In one embodiment, such selection may be performed via a user interface, such as a drop down menu for selecting the index, and reports may be provided, for example, using a variety of indexes to provide, for example, various ranges of results. Further, in other embodiments, selections of granularity of the index may also be selected.

KBDI is essentially an indicator of the amount of water missing from the top 203 mm (8 in) of soil, where 0 is the minimum value, indicating soil that is fully charged with water and there is little fire risk, while a value of 203 indicates that the soil is fully depleted, dry conditions have been prevalent, and the risk of fire is high.

The indicator is calculated by iteratively updating current values at either a daily or monthly timescale. The update at time step may be provided as:

Q(t)=Q(t−1)+dQ−dP

where Q(t) is the KBDI value on day t, Q(t−1) is the previous KBDI value, dQ is the KBDI adjustment, and dP is the precipitation total over period t in mm. dQ is calculated as:

dQ=0.001* (203.2−Qt)*(0.968*e\hat{ }(0.0875T+1.5552)−8.3)dt/(1+10.88*e\hat{ }(−0.001736R))

where T is the mean daily maximum temperature over the period t in Celsius, and R is the mean annual precipitation in mm.

In one embodiment, the KBDI calculation may be modified for a region or other area. This may be utilized in an area where the KBDI model is shown or predicted to be more accurate with adjustment, a change in constants for example. Such adjustments or changes may be an option on a user interface. The KBDI values may be utilized or modified KBDI, post-processed KBDI, or other formulas may be substituted.

Because KBDI values depend on prior values that are calculated, it may be initialized using five years of synthetic data calculated based on long-term means at a daily or monthly timescale and then run for a few years on real data that is not [necessarily] used in the analysis. In various embodiments, more or less synthetic data may be utilized. For analysis of historic KBDI to be used with fire data from 2001-2020, an initialization of an analysis using five years on [of] synthetic observations-based daily means, and then run KBDI starting from 1997, provides estimates for 2001-2020 that will be very accurate. For data on both precipitation and daily maximum temperatures, data at the 0.1 degree (˜10 km) resolution for example may be utilized from the ERA5-Land collection (other resolutions and/or other collections may also be selected via user interface), which may, for example, be downloaded at the hourly time step and aggregated to daily and monthly resolutions based on local solar midnights or other basis.

Such a model estimates the relationship between fire weather and fire risk in a given context. Therefore, variables that accurately describe the baseline ecological context (Baseline Fire Risk Variables) are desired. A selection of variables may also be made. In one embodiment, a model may have many different variables related to local context, including, for example:
19 bioclimatic variables (annual mean temperature, mean diurnal range, isothermality, temperature seasonality, max temperature of warmest month, min temperature of coldest month, temperature annual range, mean temperature of wettest quarter, mean temperature of driest quarter, mean temperature of warmest quarter, mean temperature of coldest quarter, annual precipitation, precipitation of wettest month, precipitation of driest month, precipitation seasonality, precipitation of wettest quarter, precipitation of driest quarter, precipitation of warmest quarter, and precipitation of coldest quarter)
6 land cover variables (agriculture, closed-canopy-forest, grassland, open-canopy-woodland, other, urban) each summarized over 4 distances (0 km, 0.5 km, 1 km, and 2 km)
6 topographic variables (elevation, roughness, terrain ruggedness index, aspect, slope, and topographic position index)
2 spatial index variables (latitude and longitude)
3 indicators of fire ignition sources and suppressability (distance to cities, friction surface, and subnational GDP)

In one embodiment the selection of variables may include a standard set of variables that may be weighted, excluded, and/or bias corrected. In one embodiment, the variables may be specifically selected or have their weighting changed from the standard set. For example, a region may have a larger or smaller reliance or its climate may be more or less dependent or affected by one or more variables whose selection (or non-selection) or weighting may be adjusted. Such adjustments may be performed in real time via a user interface such that changes in prediction and risk may be viewed simultaneously. The user interface could be an end user licensed product or a skilled technician's workstation where an analysis/prediction product is being prepared. The Baseline Fire Risk Variables or others may be selected and/or weighted in any combination and all such combinations are specifically claimed and disclosed as if set forth or included in a comprehensive table as provided further above.

### Observed Fire Risk

Data on fire occurrence provided globally and at a 500 meter resolution may be derived from NASA's MODIS satellite program. This dataset goes back to November 2000 and provides a binary indicator of whether a fire was observed at a given pixel at a daily timestep. From this dataset, using 240 million sample locations on a given day across the terrestrial world, oversampling fire occurrence to make up approximately 10% of the dataset, but otherwise sampling completely at random. These sample locations were combined with the average KBDI value over the year that the fire was observed as well as the 54 baseline fire risk variables. To train the model. Alternatively, the model may be trained using other datasets and resolutions if available.

### Schematic of Data Flow

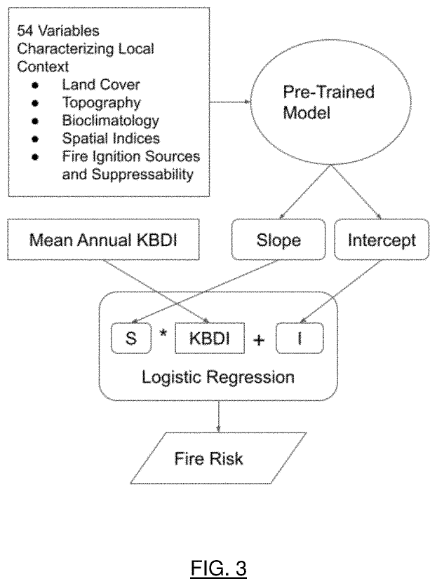

Given the aforementioned variables (e.g., 310), FIG. 3 provides a schematic 300 of the data flow in making predictions with the pre-trained model 310. The schematic below shows how they are combined with a trained model to estimate fire risk 380.

### Validation

The approach was validated by training the model on the first decade of the 21st century, and evaluating its performance on the second decade of the 21st century. The model was compared against CMIP6 predictions of burned area, a simple linear-regression based model, and also a naive model that predicts a fire risk of 0. The validation was conducted within the continental United States.

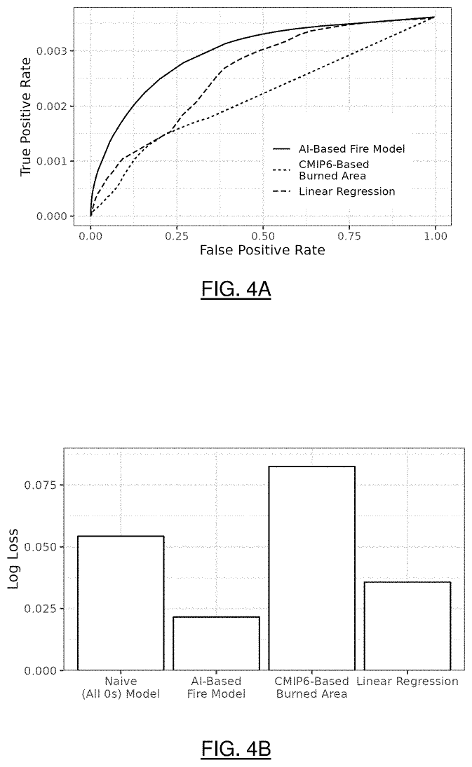

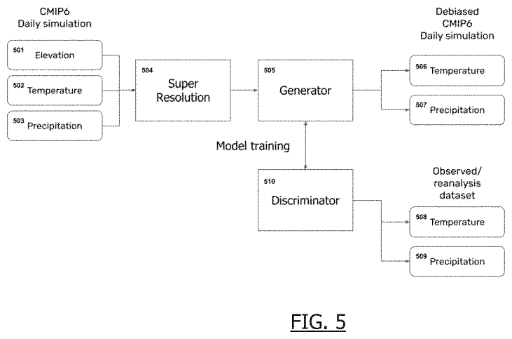

FIG. 4 and FIG. 5 graphically illustrate validation results of trained model, based on training from 2001-2009 and validating on 2010-2019.

The AI-based model performs well on log-loss, a metric for evaluating models that make probabilistic predictions and are evaluated against binary outcomes. Additionally, examining the receiver-operating characteristic, the model strikes a better balance in the tradeoff between false positives and false negatives.

Finally, comparing area burned fraction at the 1-decimal degree grid cell level across the continental USA, giving a continuous value to evaluate with common metrics such as mean average error (MAE), mean squared error (MSE), and r-squared (r2). Using this metric, the new metric had a very low MAE and MSE (0.002) and (0.0001), indicating that it was off in predicting burned area fraction by, on average, 0.01 percentage points. Additionally the r2 was 0.18, significantly better than a “naive” model predicting no fire, with an r2 of 0.07, or the standard CMIP6 burned area fraction metric, which has an r2 of −0.8.

Generative Modeling for Updating Climate exposure insights is a process that may be utilized on its own for various ends including predictions, analysis, and output or display as provided herein. For example, bias correction of temperature and precipitation using a class of AI models, generative adversarial networks (GANs). Bias correction broadly encompasses nudging modeled values to take on characteristics we expect based on observations, thus providing more accurate risk projections when looking forward. Resolution enhancement may also be planned here. The primary benchmark dataset to surpass is NASA's latest bias-corrected CMIP6 data (NASA GDDP).

Climate models inherently are imperfect simulations of the physical world. While the models incorporate known phenomena like the laws of thermodynamics, other phenomena like cloud condensation lack commonly used equations and developers are left to include their best estimates. What's more, climate models are run at spatial resolutions (e.g., too coarse) that fail to properly simulate key phenomena like convective precipitation, tropical cyclone and tornado dynamics, and local effects from topography and land cover (e.g., microclimates). This leads to a variety of known and unknown biases in fundamental variables like temperature and precipitation, whose biases then have knock-on impacts on hazard estimations. To enable local, accurate hazard models high fidelity simulations of present-day and forward looking fundamental variables is provided.

The present inventors have also realized the need to improve accuracy of Climate models by correcting errors that would otherwise reduce the accuracy of projections of climate hazards like heatwaves and flooding. Such errors include, for example, errors in bias. In one embodiment bias correction tools are provided. Indeed, forward-looking estimates of future flood risk typically use bias-corrected precipitation rather than the raw climate model data. To enable local, accurate hazard models requires high fidelity simulations of present-day and forward looking fundamental variables.

Recent advances in AI including in image super-resolution (SR), as described in co-pending patent application Ser. No. 17/529,670, “Climate Scenario Analysis And Risk Exposure Assessments At High Resolution” and unpaired image-to-image translation suggest substantial promise to improve over existing bias correction methodologies. These AI models can flexibly incorporate multivariate and spatial relationships in ways not possible with existing approaches. For instance, AI-based SR has shown superior performance in enhancing the spatial resolution of wildfires, precipitation, and wind. Meanwhile, unpaired generative adversarial networks (GANs) have shown promise in applications to temperature and precipitation.

In one embodiment, ClimaGAN, a novel SR and unpaired image-to-image translation GAN architecture operating on 3-channel geospatial datasets, incorporating temperature, precipitation, and elevation, is provided. ClimaGAN performance may be validated and compared against a NASA benchmark algorithm, showcasing ClimaGAN performance on a leading CMIP6 model over a region spanning the contiguous U.S.

High level components for the network architecture may include, for example:
Unpaired image-to-image translation
Content preservation
Spatial resolution enhancement (super-resolution)
Multivariate input and output variables

Any one or more which may be applied in any system. For example, unpaired image-to-image translation is used because the daily output from a CMIP6 model is not expected to directly match observations for the corresponding date, a challenge that occurs in bias-correction methods. For example, CMIP6 temperature simulations for Jan. 1, 2010 are not, by design, expected to match observed conditions on that date. They instead are expected to provide a realistic simulation of what the weather could have been on that date. Content preservation is that the bias-corrected output variables should maintain the content of the CMIP6 inputs while taking on the appearance of real-world conditions. Content preservation in the context of GANs is typically preserved through adding a cycle-consistency loss term. FIG. 5

### FIG. 5

The network (ClimaGAN) combines super-resolution and a contrastive unpaired translation GAN. The input LR images for elevation (501), temperature (502) and precipitation (503) are passed through the SR layer (504) that enhance spatial resolution, for example by 4× or 8×. These SR images are then passed through a generator network (505). The discriminator compares the debiased or bias corrected output images for temperature (506) and precipitation (507) with observation data for temperature (508) and precipitation(509) to discriminate using a discriminator (510) between which modeled data that resembles the ‘real world’ (observation) and data which is not resembling the real world (bias-corrected and super-resolved CMIP6).

The generator (505) and discriminator (510) networks along with the super-resolution networks (504) are trained concurrently. As the generator and discriminator improve, so does the level of bias-correction, creating output climate images that are increasingly difficult to distinguish from real-world observations. The generator consists of 9 Resnet blocks in between two upscaling layers (‘encoder’) and two downscaling layers (‘decoder’). The discriminator consists of multiple convolutional layers.

One of the advances of this network is the implementation of a contrastive unpaired translation GAN. The contrastive unpaired translation is an advancement in GANs released in 2020 from the team who created cycleGAN, a leading framework for unpaired image-to-image translation. Contrastive unpaired translation appears to outperform cycleGANs in both accuracy and efficiency. Briefly, the network incorporates a InfoNCE loss term in addition to the adversarial loss of a standard GAN. The InfoNCE loss works by sampling patches of the output image and ensuring that the samples are similar to the corresponding patches of the input image. At the same time, the InfoNCE loss discourages the sampled patches from being too similar to other patches of the input image.

ClimaGAN substantially improves CMIP6 input simulations of daily temperature and precipitation, not only enhancing spatial resolution 4× to 0.125° but also leading to reductions in bias when evaluated on the held out test set. Performance enhancement may be evaluated qualitatively by comparing maps of observed conditions against modeled. Visually, the ClimaGAN-enhanced CMIP6 conditions much better match observed compared with the raw CMIP6 input, capturing local spatial variability with higher accuracy. For example, in California, the Central Valley is reflected clearly in enhanced temperatures, while the eastward Sierra Nevada mountains are reflected by a band of elevated precipitation, distinctions not immediately apparent in the original CMIP6 data.

Performance characterization, Table 2:

| | | Standard | | |
|---|---|---|---|---|
| Model | Mean | Deviation | Skew | Q98 |
| ClimaGAN | 0.98 | 0.97 | 0.26 | 0.94 |
| NASA NEX-GDDP | 0.96 | 0.90 | 0.69 | 0.86 |
| Raw CMIP6 | 0.94 | 0.88 | 0.42 | 0.75 |

ClimaGAN applied to daily maximum temperature shows an enhancement of raw CMIP6 inputs in out of sample test set years (n=2,194 daily images) across all four evaluation metrics over the U.S. and outperforms NASA's product except for distribution skew. Q98=98th percentile. While performance in the US is illustrated, the techniques described can be applied globally at any point or region across the world. Further, although fire is the main target, the same techniques may be applied to other hazards.

### Regional Processing

Various embodiments are provided, techniques, to process risk exposure and valuation data over large spatial regions that combine values across small spatial regions using data processing techniques.

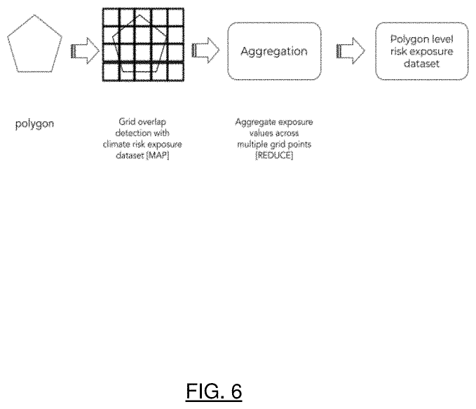

In one embodiment, risk exposure datasets are gridded datasets with varying resolution across hazards. FIG. 6 outlines how to proceed from a polygon region to a polygon level risk exposure dataset (Grid level aggregation for a single polygon). The processing flow here could be a map reduce operation going from a MAP step that detects the grid cells overlapping the polygon and a REDUCE step that aggregates the mapped grid cell values using a function that could be maximum, mean, or average across the grid cells. In other embodiments, various other mapping or aggregation functions may be utilized.

When performing the aggregation, a specified weighting function may be utilized as outlined when combining data from different grid cells. One example is to weight the grid cells in the reduce operation using population density i.e. more populated grid cells are weighted highly and less densely populated grid cells are weighted lower. In these cases a custom filter dataset can be provided or used in the MAP operation like a global population gridded dataset. The weighting may be performed differently or in other processes as well.

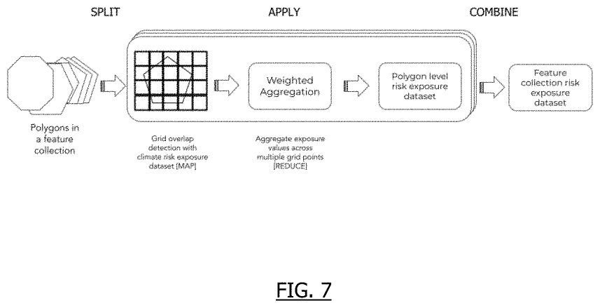

The approach is similar when processing feature collections with multiple polygons. An optimization step could be to enable parallelization using a Split-Apply-Combine processing pattern when processing the individual polygons in a collection. For example, as shown in FIG. 7, multiple polygon aggregation using Split-Apply-Combine.

### Fast Retrieval

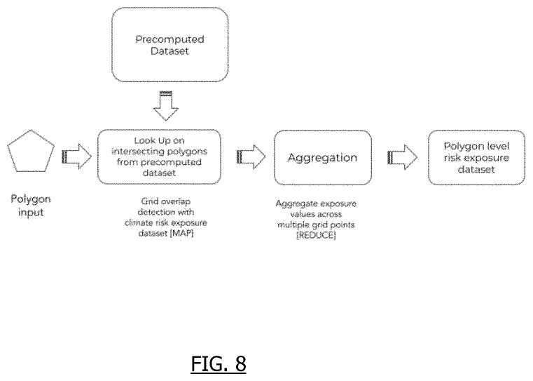

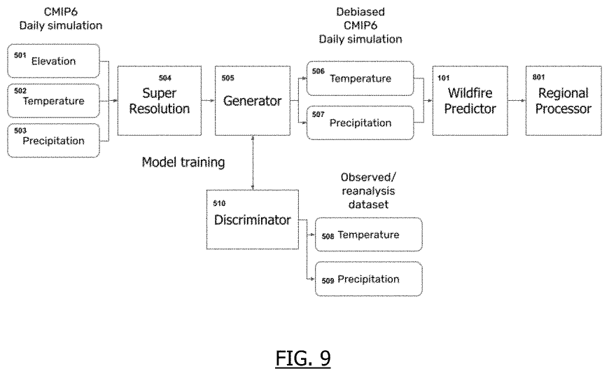

Looking at the use case to quickly serve climate risk exposure data on a single geospatial feature: a specific property (address/point) or region (polygon) (e.g., FIG. 8 Workflow for accelerated access to risk datasets). This is a meta level use case of polygon processing. For example, precompute stored data on a global administrative boundary collection. For an incoming requested address of polygon and then use the admin level data to determine the MAP (intersection and overlap) and REDUCE (aggregate) the results to provide a property or region level risk exposure dataset.

One method for high resolution, high cadence property level or regional level risk and impact analytics would be to process the bias correction models at high resolution to the wildfire predictor that can then feed the regional processor described in FIG. 6 to aggregate of risk exposure at high resolution and cadence at the desired property or region.

In one embodiment a climate model is utilized to fully analyze risk of fire or another hazard using large risk datasets. The analysis includes a display and user interface for an operator that selects and manages datasets, features, and processes operated on within a regional window for the prediction of future fire risk based on analysis provided herein. The operator's workstation displaying the user interface including a menu for the selection of features and sub-menus for tweaking constants or variables related to the features and/or long term changes such as those imposed by climate change. The selection and management of the datasets and features providing real-time output on a map (e.g., superimposed on a map) at the operator's workstation and including a before and after screen where the operator may “drag” a line of demarcation across the region where one side of the line shows results from one set of variables/features/etc., and the other side shows results of a different set. The user interface including a fast access button where the model and associated programming are accelerated using fast access techniques and shortcuts to quickly provide a result and thereby giving the operator more time to adjust parameters, which are also displayed, for example, in a legend area (e.g., a bottom corner of the display output).

Such workstation or other display powered by the processes and techniques described herein provide, for example, environmental variables is combined with satellite driven observations and ground observations to create a predictor for wildfire at high spatial resolution. Such prediction may be displayed, for example as a degree or color (e.g., red, of hue from nearly white to nearly black). Fundamental climate variables like temperature and precipitation may bias corrected (or bias adjusted corrected) using modeling and processing techniques driven from reanalysis datasets. Such techniques can be used to provide projections of future climate risk data at high temporal cadence over individual addresses or over large regions using spatial aggregation using polygon processing techniques.

Although the various embodiments have been described herein with reference to some techniques for processing, aggregating, and super-resolving (among others), it should be understood that other processes performing a similar function may be substituted without departing from the scope of the present inventions/embodiments. The present inventors specifically claim all such processes now known or developed in the future placed in a processing paradigm or enabled by a user interface that is the same or similar to those described herein.

Further, the devices and processes of the embodiments may be applied to other areas, including, for example, non-fire related hazards and other areas that make use of predictions of future events based on past data that is changing over time, such as, but not necessarily, climate change. The predictive qualities described herein with respect to climate change may also be applied to any of the variables, features, or other qualities of data or analyzable events or outcomes that have a varying, changing, or progressive nature the accounting of which will lead to more accurate predictions.

In one embodiment, the predictions are based on local climate changes such as a progression of urbanization (or changes in proximity to human development/populations) in an area. In yet another embodiment, the changes are a combination of over-all climate change (e.g. global warming) and local changes such as industrialization of an area that was previously rural, for example, the introduction of a factory town (e.g., as may be planned by SpaceX or Tesla).

In describing the embodiments, and as illustrated in the drawings, specific terminology is employed for the sake of clarity. However, the various embodiments are not intended to be limited to the specific terminology so selected, and it should be understood that the ordinarily skilled artisan may utilize similar, related, or even different terminology or technology depending on the embodiment or selected topic therein to discuss or describe the same. Further, it should be understood that each specific element includes all technical equivalents which operate in a similar manner, as will be understood by the artisan. For example, when describing an observed quantity or quality (e.g., ground based or satellite based) it should be understood that other equivalent devices or measurement techniques, or other device having an equivalent function or capability, whether or not listed herein, may be substituted therewith. Furthermore, the inventors recognize that newly developed technologies not now known may also be substituted for the described parts and still not depart from the scope of the present application or any of the embodiments. All other described items, including, but not limited to databases, processing, predictions, biases, split and/or combine, weightings, etc. should also be considered in light of any and all available equivalents.

Portions of the various embodiments may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The various embodiments, or portions thereof, may also be implemented by the preparation of application specific integrated circuits or by interconnecting an appropriate network of conventional component circuits, as will be readily apparent to those skilled in the art based on the present disclosure.

The various embodiments include a computer program product which is a storage medium (media) having instructions stored thereon/in which can be used to control, or cause, a computer to perform any of the processes of the embodiments. The storage medium can include, but is not limited to, any type of disk including floppy disks, mini disks (MD's), optical discs, DVD, HD-DVD, Blue-ray, CD-ROMS, CD or DVD RW+/−, micro-drive, and magneto-optical disks, ROMs, RAMs, EPROMs, EEPROMs, DRAMs, VRAMs, flash memory devices (including flash cards, memory sticks), magnetic or optical cards, SIM cards, MEMS, nanosystems (including molecular memory ICs), RAID devices, remote data storage/archive/warehousing, or any type of media or device suitable for storing instructions and/or data.

Stored on any one of the computer readable medium (media), the embodiments may include software for controlling both the hardware of the general purpose/specialized computer or microprocessor, and for enabling the computer or microprocessor to interact with a human user or other mechanism utilizing the results of any embodiment or variations/equivalents thereof. Such software may include, but is not limited to, device drivers, operating systems, and user applications. Ultimately, such computer readable media further includes software for performing any embodiment as described above and equivalents thereof.

Included in the programming (software) of the general/specialized computer or microprocessor are software modules for implementing the teachings of the various embodiments, including, but not limited to, data aggregation, super resolution, Generators, Discriminator/s, Polygon identification, Grid overlap detection, and the display, storage, or communication of results according to the processes as described herein (including user interface features allowing for adjustment or selection of climate change, rates, or other values and the display of results over a map, for example) and equivalent processes whether or not described herein.

The various embodiments include those necessarily rooted in computer technology in order to overcome problems specifically arising in the realm of computer networks, such as fast retrieval discussed above. And, for example, application of any of the claims or any embodiment reciting improvements that provide the same.

In one embodiment, the various processes or embodiments described herein, individually or combined, are specifically performed via electronics, computer programming, or other devices and specifically exclude any use of organized human behavior, human thought processes, mental process, calculations, or the like—as those terms are either statutorily defined, judicially interpreted, or implicated under 35 USC 101 with respect to patentable subject matter and abstract concepts. For example, in such embodiment, each process (or step of a process, device, or any limitation whether functional or structural) within any claim derived therefrom does not include any mental process, human thought, calculation, or organization (unless specifically included as such). Further, each embodiment described herein includes an alternative, whether or not already described, where one process contained therein does not include any abstract concept, abstraction, human thought, calculation, or organization. Similarly, each embodiment described herein includes alternatives, where any of two, three, or rather any number of processes contained therein in any combination do not include any abstractions, mental process, or human thought, calculation, or organization.

Applicant hereby further reserves the right to disclaim any portion of any claim from any form of abstraction, mental process, any human thought, any human/mental calculation, or any human/mental/abstract organization from any of the claims now or later presented with respect hereto. Such disclaimer may be specifically applied to a claim as a whole or any part, clause, or limitation individually or in any combination as contained in or be part of any claim.

Applicant hereby asserts that each embodiment described herein along with the various combinations whether or specifically denoted herein each represent an advance in the field and enumerated in the various embodiments and examples hereby provided. The various described embodiments include various combinations of elements (such as steps or elements of the attached claims which may be embodied in one or more clauses therein) each of which are important parts of the advance provided by the combination of elements. Further, while the various elements on their own improve the art and may be utilized in other systems, those elements together, as claimed, represent an important advance that will improve and advance systems of related purposes to which they may be applied (e.g., fast retrieval).

Applicant asserts that the present inventions use of any computer devices, mobile devices or other platforms is to obtain the desired and improved result representing an advance over known techniques. Any characterization that the steps or process together are suitable for human or mental processes is likely incorrect. In fact, using a human mental processes interjects that human platform into where the invention is being performed and may change or alter the result of the invention. In some cases, it may be shown that such human process will not work to provide the desired result or that will be different when having to interact with a person or persons and communicate, for example with a display or other device without being less useful (if at all) and/or prohibitively expensive. And again, Applicant respectfully reserves the right to exclude such person or persons, and any mental process, from any claim unless specifically provide therein.

With all of the above in context, various Enumerated Example Embodiments (EEEs) are now provided, namely:
(EEE1) (Wildfire indicator set) A method for automatically preparing and applying data transformations to existing climate related projection indicators by combining the following: a set of projections of climate variables from varied sources that are optionally harmonized to the same spatial and temporal resolution, a set of historic observations of climate variables from varied sources that are optionally harmonized to the same spatial and temporal resolution, a set of historic estimates of the indicator over an extended period of time, a data profile representing the climate zones across varied geographies, and a land cover profile representing environmental factors across varied geographies.
(EEE2)The method according to EEE1, further comprising of a machine learning module that learns to use these datasets to learn risk exposure susceptibility metrics, and creates projections of risk exposure metrics based on future projections environmental factors.
(EEE3)The method according to EEE2 that account for variations across climate zones.
(EEE3.5) The method according to EEE2 wherein the method accounts for variations across climate zones including variation in progressive human development over time in the future.
(EEE4)The method according to EEE3 that accounts for environmental land cover profiles.
(EEE5)The method according to EEE4 that uses satellite data from multiple sensors for the historic observations and land cover profiles.
(EEE6)The method according the EEE1-5, where in the projections comprises of a plurality of data streams where in at least one of the data stream is super resolved to match the highest resolution of other streams.
(EEE7)The method according the EEE1-5, where in the projections comprises of a plurality of data streams where in at least one of the data stream from the satellite sensors is super resolved to match the highest resolution of other streams.
(EEE8)The method according to any of EEE1-14, wherein super-resolution is performed according to any of the techniques described in co-pending patent application Ser. No. 17/529,670, “Climate Scenario Analysis And Risk Exposure Assessments At High Resolution”.
(EEE9)(Bias correction and generative modeling set) A method of updating and/or correcting biases in model simulations based on a generative machine learning system that learns the properties of the climate projections from historic observations.
(EEE10)A method of according to EEE9 for updating and/or correcting biases in model simulations based on a generative adversarial machine learning system.
(EEE11)A method according to EEE10 that uses one or more of climate observations, topography, land cover or other environmental sensor data as inputs to the discriminator module in the generative adversarial machine learning system.
(EEE12)A method according to EEE11 that uses one or more of satellite derived data observations as inputs to the discriminator module in the generative adversarial machine learning system.
(EEE13)A method according to EEE11 that uses historic weather observations as inputs to the discriminator module in the generative adversarial machine learning system.
(EEE14)A method according to EEE13 where the inputs to the modeling system or the outputs are super resolved for high spatial resolution of the projections from the generative adversarial machine learning system.
(EEE15)The method according to any of EEE9-14, wherein super-resolution is performed according to any of the techniques described in co-pending patent application Ser. No. 17/529,670, “Climate Scenario Analysis And Risk Exposure Assessments At High Resolution”.
(EEE16)(Polygon processing set) A method comprising of learning and processing modules that comprises of:
   Distributed processing of spatial inputs served as a spatial feature which would be one of the polygons, line strings, points or multipolygons
   Filtering weights based on the region of processing
   Mapping of polygons to a specific set of grid cells representing climate projections from a plurality of models
   Weighting and aggregating the values from multiple grid cells to a single value for each spatial feature.
(EEE17)A method according to EEE16 where:
   The system precomputes polygon based outcomes and stored in memory or in a database A incoming polygon is spatially matched with one or more precomputed polygons through a spatial intersection or overlap
   The intersecting polygons are aggregated to serve an outcome for each polygon.
(EEE18)A method according to EEE17 where the precomputation uses a super resolved risk exposure data stream in advance of storage in memory or in a database.
(EEE19)A method according to EEE17 where the precomputation factors in the spatial resolution of regions and applies super resolution to a specific set of polygons based on the resolution of the polygon.
(EEE20)The method according to any of EEE16-19, wherein super-resolution is performed according to any of the techniques described in co-pending patent application Ser. No. 17/529,670, “Climate Scenario Analysis And Risk Exposure Assessments At High Resolution”.
(EEE21)A method consisting of a user interface displaying risk exposure at an asset or property level that indicates the risk exposure computed as a result of processing indicated by claims 1-20 on a map which shows a collection of assets as points or regions as polygons.
(EEE22)A method comprising of a user interface according to EEE21 that includes a representation of risk exposure at a regional level as a reference level of exposure that can optionally be surfaces through the click of a button

The embodiments may suitably comprise, consist of, or consist essentially of, any of element (the various parts or features of the embodiments, e.g., Super Resolution module/s, Generators, Discriminator/s, Polygon identification, Grid overlap detection, Aggregator/s, etc. and their equivalents as described herein. Further, the embodiments illustratively disclosed herein may be practiced in the absence of any element, whether or not specifically disclosed herein. Obviously, numerous modifications and variations of each embodiment are possible in light of the above teachings. It is therefore to be understood that within the scope of any claims, the invention, or any embodiment thereof, may be practiced otherwise than as specifically described herein.

What is claimed is:

1. A method for climate risk analysis, comprising the steps of:
preparing or retrieving a set of projections of climate variables from varied sources that are optionally harmonized to the same spatial and temporal resolution;
preparing or retrieving a set of historic observations of climate variables from varied sources that are optionally harmonized to the same spatial and temporal resolution;
preparing or retrieving a set of historic estimates of the indicator over an extended period of time;
preparing or retrieving a data profile representing the climate zones across at least one geography;
preparing or retrieving at least one land cover profile representing environmental factors across the geographies; and
automatically preparing and applying data transformations to the projections in light of the observations, estimates, and profiles to determine a climate related risk.

2. The method according to claim 1, further comprising a machine learning module that learns to use datasets comprising one or more of the observations, estimates, and profiles to learn risk exposure susceptibility metrics and create projections of risk exposure metrics based on future projections and environmental factors.

3. The method according to claim 2 wherein the projections of risk exposure metrics accounts for environmental land cover profiles.

4. The method according to claim 3 wherein satellite data from multiple sensors are utilized for the historic observations and land cover profiles.

5. The method according the claim 1, wherein at least one of the projections comprises of a plurality of data streams where in at least one of the data streams is super resolved to match a highest resolution of other streams.

6. The method according the claim 1, wherein the projections comprise of a plurality of data streams where in at least one of the data streams is from a satellite sensor and is super resolved to match the highest resolution of other streams.

7. The method according to claim 5, wherein super-resolution is performed according to any of the techniques described in co-pending patent application Ser. No. 17/529,670, “Climate Scenario Analysis And Risk Exposure Assessments At High Resolution”.

8. A method of updating and/or correcting biases in model simulations based on a generative machine learning system that learns the properties of climate projections from historic observations.

9. The method of according to claim 8, further comprising updating and/or correcting biases in model simulations based on a generative adversarial machine learning system

10. The method according to claim 9, further comprising using one or more of climate observations, topography, land cover, and/or other environmental sensor data as inputs to a discriminator module in the generative adversarial machine learning system.

11. The method according to claim 10 that uses historic weather observations as inputs to the discriminator module in the generative adversarial machine learning system

12. The method according to claim 11 wherein the inputs to the modeling system or the outputs are super resolved for high spatial resolution of projections from the generative adversarial machine learning system

13. The method according to any of claim 12, wherein the super-resolution is performed according to any of the techniques described in co-pending patent application Ser. No. 17/529,670, “Climate Scenario Analysis And Risk Exposure Assessments At High Resolution”.

14. A method comprising of learning and processing modules that comprises:
performing a distributed processing of spatial inputs served as a spatial feature which would be one of the polygons, line strings, points or multipolygons;
filtering weights based on the region of processing;
mapping of polygons to a specific set of grid cells representing climate projections from a plurality of models; and
weighting and aggregating the values from multiple grid cells to a single value for each spatial feature

15. The method according to claim 14 where:
the method precomputes polygon based outcomes and stored in memory or in a database;
an incoming polygon is spatially matched with one or more precomputed polygons through a spatial intersection or overlap of the intersecting polygons are aggregated to serve an outcome for each polygon.

16. The method according to claim 15 where the precomputation uses a super resolved risk exposure data stream in advance of storage in memory or in a database.

17. The method according to claim 16 where the precomputation factors in the spatial resolution of regions and applies super resolution to a specific set of polygons based on the resolution of the polygon.

18. The method according to claim 14 further comprising a user interface displaying risk exposure at an asset or property level that indicates the risk exposure computed as a result of processing indicated by claim 14 shown on a map which comprises a collection of assets as points or regions as polygons.

19. The method according to claim 18, the user interface further comprising options to adjust any of the spatial inputs and/or features or any of the weights, mappings, or aggregations and display a before and after visual representation of a climate risk scenario determined from the steps described in claim 14.

20. The method according to claim 19, wherein the user interface includes a super-resolution button that applies super-resolution to one or more of the spatial inputs which may be selected on the user interface.
